(19) United States
(12) Patent Application Publication
(10) Pub. No.: US 2015/0078832 A1
(43) Pub. Date: Mar. 19, 2015

(54) Pipeline Lifting and Supporting Apparatus For Maintenance and Restoration Purposes

(71) Applicant: Shlomo Kline, Herzliya (IL)

(72) Inventor: Shlomo Kline, Herzliya (IL)

(21) Appl. No.: 14/395,806

(22) PCT Filed: Jan. 30, 2013
(86) PCT No.: PCT/IL2013/050079

§ 371 Date: Oct. 20, 2014

Related U.S. Application Data
(60) Provisional application No. 61/736,840, filed on Dec. 13, 2012.

(51) Int. Cl. F16L 1/032

(52) U.S. Cl. CPC F16L 1/032
USPC 405/184.1

(57) ABSTRACT

Apparatus for lifting and supporting pipelines through which is flowable fuel, gas or hazardous industrial liquids, for maintenance and restoration purposes, which comprises a hybrid sling for supporting a pipeline segment when being raised, where the sling comprises a flexible belt portion contacting an underside of the pipeline segment and a chain portion vertically extending from each end of the belt portions to an element through which a lifting force is transmittable. The sling is assured of being sufficiently structurally strong and dimensionally stable to ensure that the difference in height of any two points of the segment when being raised is not so great as to create a danger to the integrity of the pipeline.

### FIELD OF THE INVENTION

This invention refers to an apparatus for lifting and supporting pipelines through which is flowable fuel, gas or hazardous industrial liquids, in order to carry out maintenance and restoration.

### BACKGROUND OF THE INVENTION

Pipelines used to transport products such as fuel, gas or hazardous industrial liquids, particularly fuel pipelines, require periodic maintenance which involves cleaning their outer surfaces, performing the required repairs and providing them with new and advanced protective coating, e.g., coating for protecting the outer surfaces of the pipes from corrosion.

Generally, the decision when to perform pipeline maintenance is made according to one of two approaches—according to the preventative maintenance approach or the post damage repair approach. Many companies carry out systematic examinations of pipelines, using advanced instrumentation in order to prevent recurrence of failure events by taking preventive maintenance measures. On the other hand, some companies prefer to take emergency restoration measures, due to cost saving considerations, only once a failure occurred or is about to take place.

Regardless of the approach, the overall maintenance and restoration operations are extremely heavy and costly since a relevant global pipeline network may extend for hundreds of miles in length.

It will be appreciated that any damage to a pipeline, involving failure thereof and spillage of the transported liquid, would constitute, apart from the economical damage, a major ecological disaster including a significant risk of fire, explosions and loss of life. Therefore those responsible will never initiate a maintenance operation that involves even a very small probability of such damage and failure.

Each pipeline section that requires a maintenance operation is generally exposed by excavating soil from the sides of a trench in which the pipeline is embedded and under the pipeline, in order to provide sufficient space within the trench and on both sides of the exposed pipeline, in order to enable performance of the required maintenance operations.

In many cases, the pipeline trenches cross rough ground such as rock formations or difficult topographic conditions that requires lengthy and expensive operations. It will be appreciated that while the ground may have been comminuted to some extent on the sides, when a trench was dug for the laying of the pipeline, the bottom of the trench, filled with carefully selected padding material, is intact. It should be pointed out that digging underneath the pipeline in any ground type will compromise the integrity of the original trench bed and additional costs are incurred in restoring the trench bed to a state suitable for supporting the pipeline in the future.

U.S. Pat. No. 7,845,881 discloses a method and apparatus for lifting pipelines without having to dig significantly therebelow, often into hard rock beds. The apparatus includes at least one lifting frame having telescopic legs and a top beam connecting the legs, telescopic lifting arms supported by the beam, and a chain or a belt connected to the lifting arms for engaging the bottom of the pipeline. The telescopic legs are extended until the chain or belt is tightened. The lifting arms are then retracted to raise the pipeline. A number of points are selected along the pipeline, and the pipeline is raised at these points by an amount that the height difference between these points does not exceed the international flexibility standards regarding the maximum allowable stress for oil and gas pipelines. Other standards have been determined, for safety and integrity of pipelines for carrying hazardous materials, such as:
European standard BS EN 14161 (Petroleum and natural gas industries)
European standard BS EN 1594 (Gas supply systems)
British Standard Code of Practice for Pipelines BS PD 8010
American Petroleum Institute standards API 17B, API 17TR2, API RP 579 and others

Although this method is effective in terms of raising a pipeline segment in order to perform a maintenance operation thereto while complying with international flexibility standards, the chain or belt engaged with the bottom of a pipeline segment constitutes a significant safety hazard.

A chain comprising a plurality of interconnected elliptical links has maximum tensile strength along the major axis of each link. However, the orientation of may of the links may be changed to a position that does not exploit this maximum tensile strength when the chain is caused to be engaged with the bottom of a curved pipeline segment.

At times, as shown in FIG. 1, a link 2 of a chain 9 adapted to support a pipeline segment 5 from the bottom is liable to change its orientation by as much as 90 degrees from an adjacent link 4 with which it is interconnected. The bottom periphery of pipeline segment 5 therefore becomes in contact with the upper end of link 2 while is spaced from link 4. As a result, the protruding link 2 supports the entire weight of pipeline segment 5 by point contact and eventually causes portion 8 of the pipeline segment contacted by link 2 to be damaged, or even collapse. Such damage can seriously compromise the structural integrity of the pipeline and lead to an ecological disaster. Additionally, the tensile force of chain. 9 is transmitted through the minor axis of link 2, leading to a relatively high stress concentration that can cause structural failure.

Monolithic belts made of a web, such as woven material or rope, are more advantageous for supporting the bottom of a pipeline segment than hard metal chains that consist of a plurality of angularly displaceable links. However, belts have a tendency of stretching to a certain extent. Accordingly, a pipeline segment at times may be unknowingly raised more than the maximum height difference permitted by the international flexibility standards as a result of the belt elongation, leading to pipeline failure. Furthermore, the belt elongation cannot always be anticipated since a belt generally exhibits non-linear elongation characteristics that may result in a different value of elongation for a same load.

It is therefore an object of the present invention to provide an apparatus and method for lifting and supporting pipelines by which any danger of damage or failure to the pipeline is eliminated as a consequence of the lifting and maintenance operation.

It is an additional object of the present invention to provide an apparatus and method that will obviate the need for considerable digging under the pipeline into the trench bed, particularly when it is hard rock bed.

It is an additional object of the present invention to provide such an apparatus and method which involve considerable savings in terms of time and costs during maintenance of pipelines.

It is yet an additional object of the present invention to provide such an apparatus that can be easily operated by unskilled workers, to minimize the risk of human error.

Other purposes and advantages of the invention will become apparent as the description proceeds.

### SUMMARY OF THE INVENTION

The present invention is directed to apparatus for lifting and supporting pipelines through which is flowable fuel, gas or hazardous industrial liquids, for maintenance and restoration purposes, comprising a hybrid sling for supporting a pipeline segment when being raised, said sling comprising a flexible belt portion contacting an underside of said pipeline segment and a chain portion vertically extending from each end of said belt portions to an element through which a lifting force is transmittable, wherein said sling is assured of being sufficiently structurally strong and dimensionally stable to ensure that the difference in height of any two points of said segment when being raised is not so great as to create a danger to the integrity of the pipeline.

In one aspect, each of the chain portions is connected to a raisable member of a lifting apparatus through which the lifting force is transmittable, said lifting apparatus comprising two transversally spaced lifting frames awl a transversally extending beam interconnected with said two lifting frames.

The apparatus preferably comprises a first hydraulic system for telescopically extending and retracting a corresponding foot on which each of the two lifting frames rests, wherein said first hydraulic system has insufficient power to extend said foot to lift the pipeline, and a second hydraulic system independent from said first hydraulic system for applying the lifting force to lift the pipeline or a lowering force to lower the pipeline.

In one aspect, the first and second hydraulic systems are positioned with an interior of each of the two lifting frames and a piston of the first hydraulic system is connected to the corresponding foot.

In one aspect, the raisable member is a longitudinally extending beam that passes through, and is engaged by, a corresponding lifting frame and a piston of the second hydraulic system is configured to apply a lifting or lowering force to a pin attached to the corresponding lifting frame, the lifting or lowering force applied to said pin being transmitted to the longitudinally extending beam.

In one aspect, the pin is releasably attachable to a block which is positioned in abutting engagement with an inner face of the corresponding lifting frame and is connected to the piston of the second hydraulic system, a selected attachment position of the pin in one of a plurality of apertures formed in the corresponding lifting frame defining a stroke of the piston of the second hydraulic system and a height to which the pipeline segment is raised.

In one aspect, a reinforcing element is welded to an outer face of the corresponding lifting frame in the vicinity of the pin and the longitudinally extending beam.

In one aspect, the raisable member is a telescopic lifting arm.

In one aspect, the transversally extending beam is dimensionally adjustable.

In one aspect, the apparatus further comprises two longitudinally separated and manually actuated force applicators that are engageable with a top of the pipeline segment.

In one aspect, a longitudinally extending support beam passes through a corresponding lifting frame and is raisable by a crane.

In one aspect, the apparatus further comprises a crane related chain connected to, and extending upwardly from a corresponding support beam disposed at a same angular disposition with respect to a horizontal plane as the pipeline segment and a hook element connected to a crane, for supporting a central portion of the two crane related chains and thereby allowing the pipeline segment to be raised by the crane in a direction parallel to an inclined disposition of terrain in which the pipeline is embedded. Each crane related chain is connected to the corresponding support beam by means of partially open eyelets protruding from the corresponding support beam.

In one aspect, the belt portion is resistant to acids and has an elongation ranging from 3 to 5%.

In one aspect, the belt portion is made from polyester.

In one aspect, two longitudinal ends of the pipeline segment are supported by a corresponding sliding cradle assembly.

In one aspect, a support is in contact with the pipeline at a corresponding lifting location, said support including one or more stackable elements including a concave element for engaging the bottom of the pipeline, wherein said concave element has a substantially similar curvature as that of the pipeline to conform to the surface of the pipeline.

In one aspect, the difference in height between any two adjacent points of the pipeline is less than a permissible vertical displacement value in accordance with a flexibility standard.

The present invention is also directed to a support assembly for a longitudinal end of a raised pipeline segment through which is flowable fuel, gas or hazardous industrial liquids, comprising a sliding cradle assembly that includes a concave portion for engaging a bottom of a raised pipeline segment and that is transversally slidable in response to an applied temperature related, pipe derived force.

In one aspect, the sliding cradle assembly comprises a monolithic member configured with the concave portion and two rectilinear portions between which the concave portion is interposed, at least one rectilinear supporting block, a plurality of transversally spaced rollers placed on top of an uppermost layer of said at, least one supporting block, and two longitudinally extending position limit elements affixed to said uppermost layer of supporting blocks and transversally spaced from transversal ends, respectively, of said monolithic member, a maximum transversal displacement of said monolithic member being defined by a position of said two position limit elements.

### BRIEF DESCRIPTION OF THE DRAWINGS

In the drawings:

FIG. 1 is a front view of a prior art chain supporting the bottom of a pipeline segment, showing the damage that the chain can cause to the pipeline segment;

FIG. 2A is a schematic vertical view of a lifting apparatus according to an embodiment of the invention, seen from a plane perpendicular to the axis of the pipeline;

FIG. 2B is a schematic vertical view of the apparatus of FIG. 2A, seen from a plane parallel to the axis of the pipeline;

FIGS. 2C and 2D schematically illustrate two stages of the lifting of the pipeline with the apparatus of FIG. 2A;

FIG. 2E is a schematic vertical view of a lifting apparatus according to another embodiment of the invention, seen from a plane perpendicular to the axis of the pipeline;

FIG. 3 is a perspective view of a lifting apparatus according to another embodiment of the invention;

FIGS. 4-6 are a front view of the lifting apparatus of FIG. 3, shown in three successive stages, respectively, of a lifting operation;

FIG. 7A is a side view of the lifting apparatus of FIG. 3;

FIG. 7B is an enlarged cross sectional view of the lifting apparatus of FIG. 3, cut about plane A-A;

FIG. 8 is a top view of the lifting apparatus of FIG. 3;

FIGS. 9a-e schematically illustrate a pipeline lifting procedure;

FIG. 10 is a perspective view of the lifting apparatus of FIG. 3 being involved in a lifting operation over inclined terrain;

FIG. 11 is a front view of a sliding cradle assembly;

FIG. 12 is a perspective view of the sliding cradle assembly of FIG. 11; and

FIGS. 13A and 13B are side views of a lifted pipeline segment when being supported at each longitudinal end thereof by a corresponding sliding cradle assembly of FIG. 11.

### DETAILED DESCRIPTION OF PREFERRED EMBODIMENTS

The present invention is directed to a novel elongated and flexible element for supporting the bottom of a pipeline segment (hereinafter referred to as a “sling”) which is hybrid in the sense that it comprises two portions, a belt portion that contacts the underside of the pipeline segment and a chain portion having links that are assured of remaining in vertical alignment without being angularly displaced. The sling is connecting to a lifting apparatus that is able to limit the degree of bending of a pipeline segment to a permissible value.

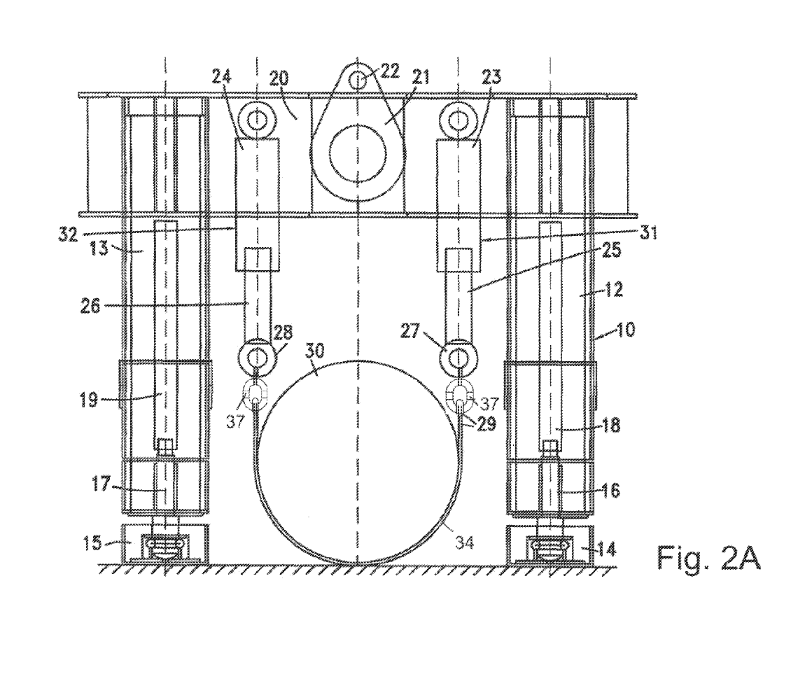

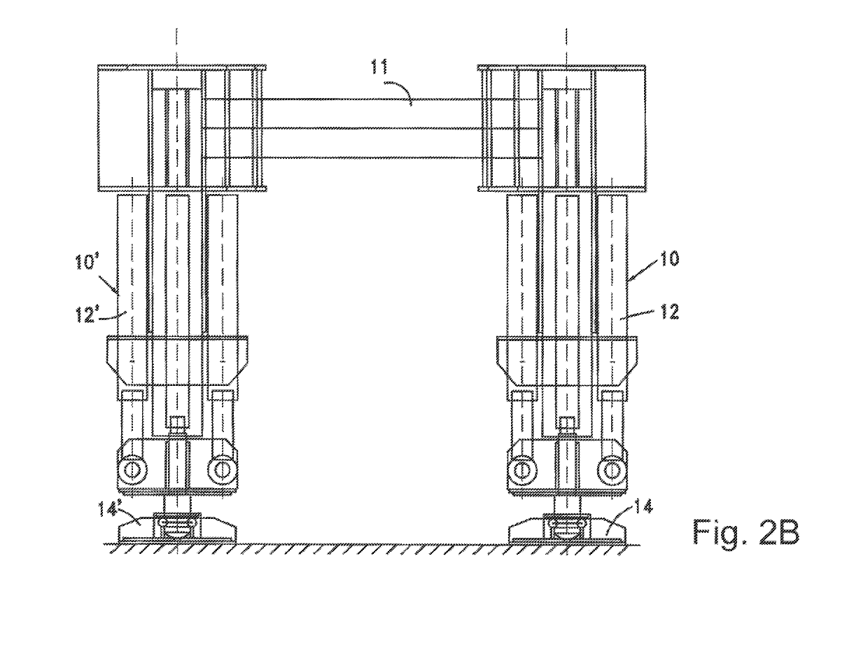

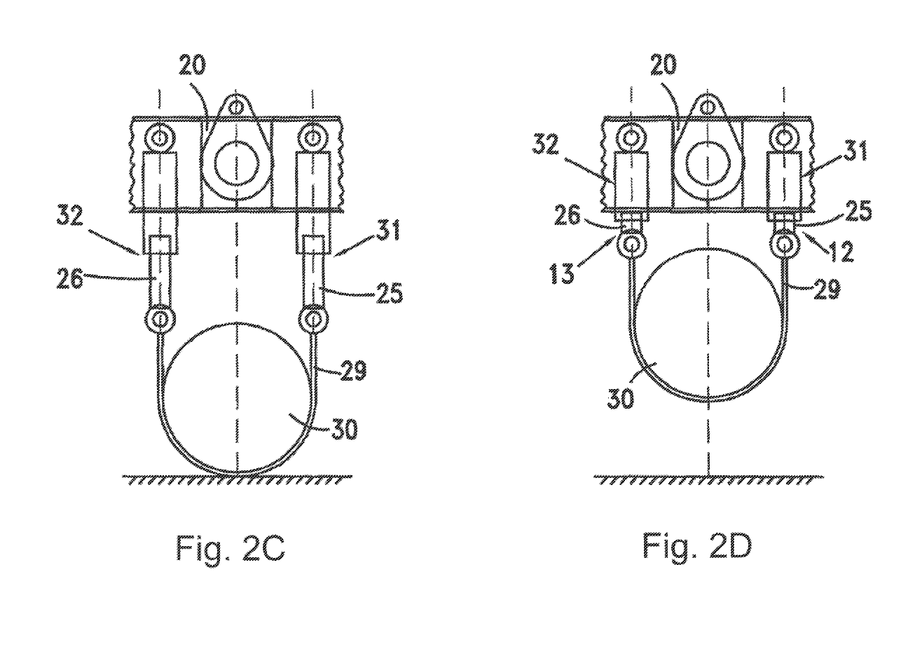

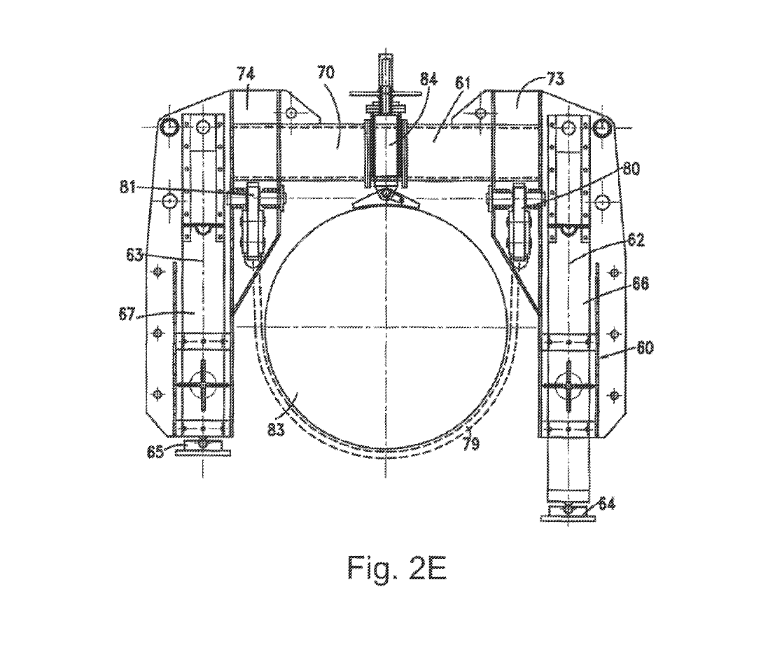

Reference is first made to FIG. 2A, which schematically illustrates a sling 29, according to one embodiment of the invention, when connected to the lifting apparatus and in supporting relation with a pipeline 30. Sling 29 comprises belt portion 34 which is in engagement with the underside of pipeline segment 30 instead of chain, the links of which are liable to be angularly displaced and to damage the pipe. In addition, sling 29 comprises two vertically disposed chain portions 37, each of which extending from a corresponding end of belt portion 34 and terminating at a free end that is connected to the lifting apparatus. The chain portions 37 provide good strength during a lifting operation and their links are retained in vertical alignment.

Since sling 29 comprises chain portion 37 that vertically extends from pipeline segment 30 to the lifting apparatus, the length of belt portion 34 contacting the underside of pipeline segment 30 is able to minimized. The elongation of belt portion 34 is therefore able to be minimized due to its reduced length, thereby ensuring that pipeline segment 30 will not be raised more than the maximum height difference permitted by the international flexibility standards as a result of unforeseen elongation. In addition, using a belt portion 34 allows compensating for possible deformations in the cross-sectional area of the pipeline. Such deformations may occur due to the fact that the pipeline is full or empty. When being full with oil, the oil weight may cause the pipeline to be slightly oval, rather than circular (when empty), depending on the weight and the thickness of the pipeline wall. In this case, the belt portion 34 adjusts itself to any deformation, so as to maintain good grasp under any condition.

Although belt portion 34 may he made of many different types of material, it has been found that polyester is a preferred material due to its relatively high load capacity, good flexibility that facilitates engagement with pipeline segment 30, resistance to acidic environments, and a low elongation ranging from 3-5%.

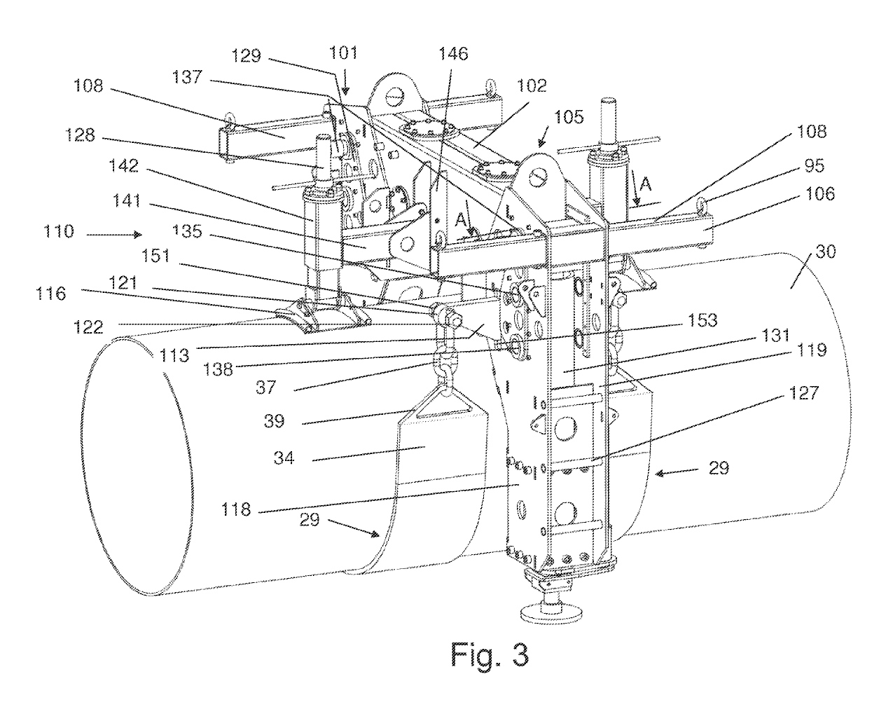

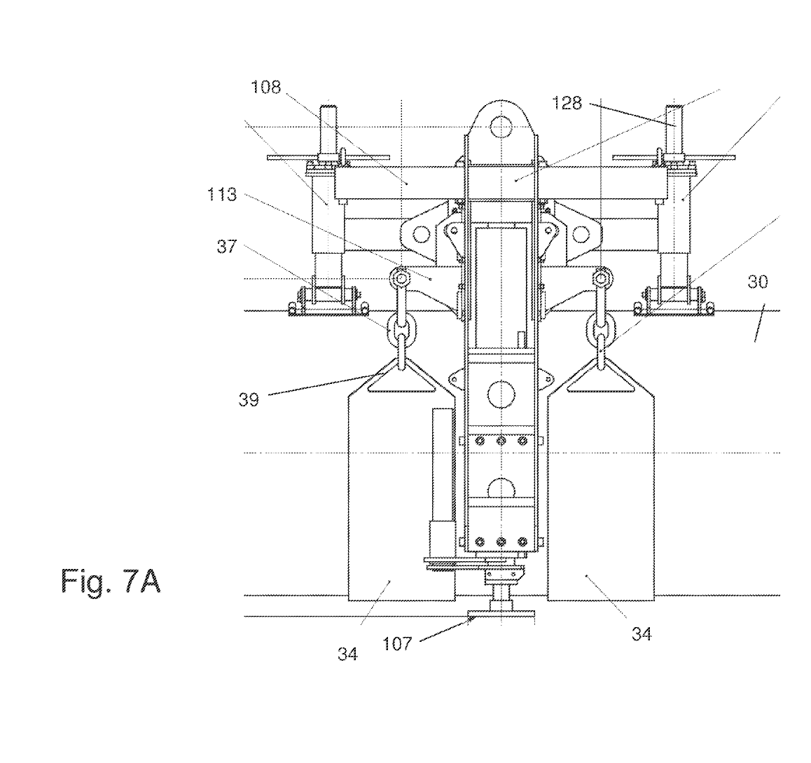

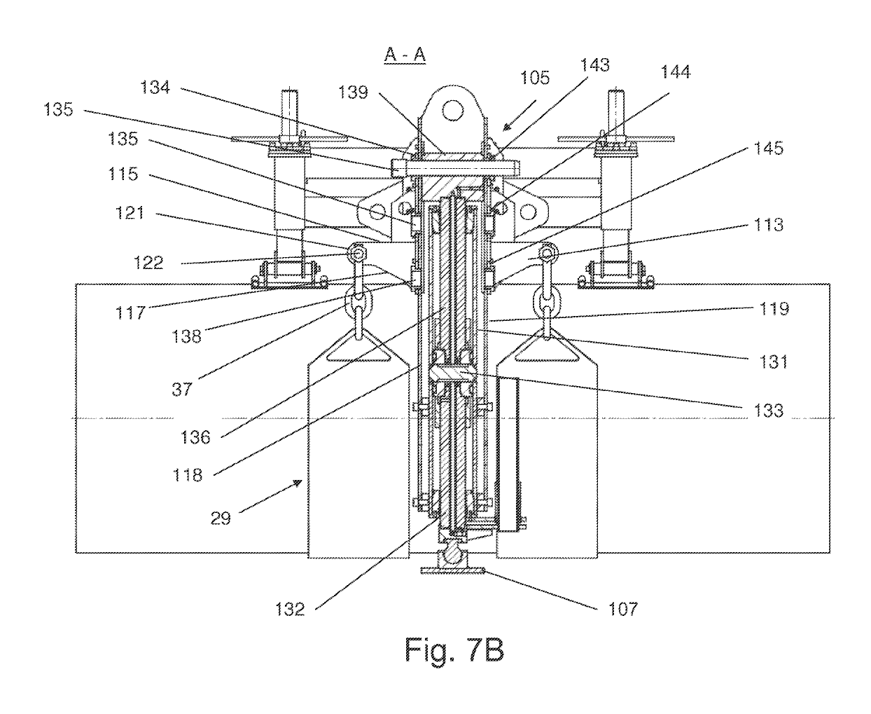

Belt portion 34 may he connected to the two chain portions 37 by any suitable means, for example by a triangular fitting 39 shown in FIGS. 3 and 7A-B.

An embodiment of the lifting apparatus is illustrated in FIGS. 2A-D and comprises two longitudinally spaced and vertically extending lifting frames that are equal and parallel to each other. The two lifting frames are generally indicated at 10 and 10′ and are interconnected by a longitudinally extending beam 11. When the lifting apparatus is placed in the pipeline trench., the frames are perpendicular to the trench and consequently the beam 11 is parallel to the trench. In the following description, for clarity's sake, the term “longitudinal” will mean approximately parallel to the axis of the trench and the term “transverse” will mean approximately perpendicular to the axis of the trench. One of the frames (frame 10) is shown in vertical view in FIG. 2A. It comprises two telescopic legs 12 and 13. Each leg rests on a foot, 14 and 15 respectively, to which are connected pistons 16 and 17 respectively, actuated by hydraulic systems schematically indicated at 18 and 19 respectively. Legs 12 and 13 are connected by a transverse beam 20 to which may be connected a link 21 having an opening 22 for lifting the frame by means of a crane. The crane will he equipped with lifting fingers, not illustrated, that concurrently seize link 21 of frame 10 and the corresponding link 21′, not visible in the drawings, of frame 10′, to lift the entire apparatus as a single body. Such crane operations are conventional and need not be further described or illustrated.

In the transverse beam 20 are housed cylinders 23 and 24 respectively of two hydraulic, extendable lifting arms, generally indicated at 31 and 32, which comprise pistons 25 and 26 respectively. Said pistons are bidirectional pistons which can extend and retract with sufficient power. The lifting arms also comprise lifting fingers attached to said pistons, for connecting thereto sling 29 which is adapted to be placed about the pipeline, the cross-section of which is illustrated at 30. Said fingers are schematically indicated in FIG. 2A as rings 27 and 28, but may, and generally will have different structures.

The operation of the apparatus is as follows. The apparatus is placed in the trench astride the pipeline, as seen in FIGS. 2A and 2C. A few centimeters are removed from the trench bed under the section of the pipe that has to be engaged by the lifting apparatus, and the sling 29 is passed underneath the pipe and is connected to the lifting fingers 27 and 28. Then the hydraulic apparatus 18 and 19 are actuated so as to extend the telescopic legs 12 and 13 until the sling 29 is tight. The actuation of the hydraulic apparatus also serves to set the lifting frames in the proper positioned relationship to the trench, with their legs vertical as far as possible. The power of the hydraulic systems 18 and 19 is so limited that they can cause the legs 12 and 13 to be telescopically extended to place the frame in a correct positioned relationship to the trench and to tighten the sling, but they cannot raise a pipeline segment loaded with a hazardous industrial liquid, the weight of which is in the order of tens of tons and is much greater than that of the lifting frames. What has been said of one lifting frame applies to both of them, when the apparatus comprises two lifting frames, as in this embodiment.

Thereafter, the lifting arms are hydraulically actuated so as to retract and lift the pipe 30 (see FIG. 2D). The apparatus is so dimensioned that the entire stroke of the lifting arms is 22 cm or whatever other amount might be determined by international standards. The apparatus cannot lift the pipe by more than said amount, because its stroke is structurally limited, by any suitable structural means, and cannot be exceeded as a result of operating errors. For example, the piston of the lifting arm may be so manufactured so that its stroke is only 22 cm.

The hydraulic pumps which supply the lifting power to the telescopic legs on the one hand and to the lifting arms on the other hand, are mutually independent. In this way it can be guaranteed that the power of the telescopic legs will always be well below that necessary to lift the pipe.

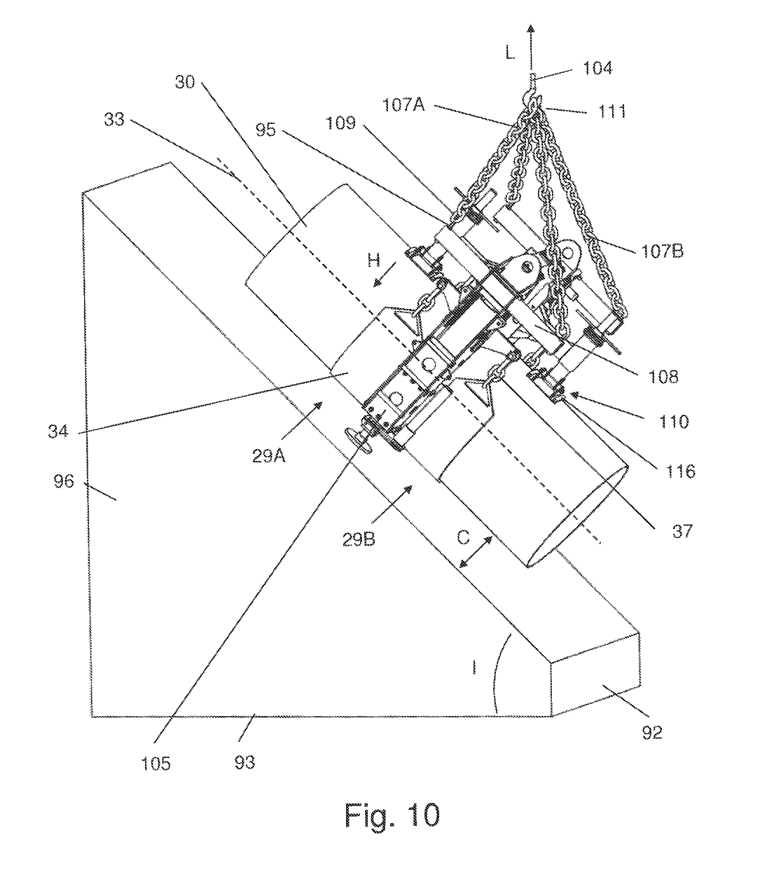

The use of these stackable supports during the maintenance procedure is schematically illustrated in FIGS. 10a to 10e.

Pipelines have a certain flexibility which, small as it is, can result in significant bending over length of pipeline of tens of meters. International standards limit the permissible degree of bending in a very strict manner to assure that it should not be so great as to create a danger to the integrity of the pipeline. For example, such standards permit vertically to displace a cross-section of a standard fuel 42″ pipeline by up to and no more than 22 cm over a length of 30 meters. This means that if one cross-section of the pipeline is kept still, another cross-section which is spaced from the first one by 30 meters may be raised, without danger of failure or damage to the pipeline by up to and no more than 22 cm. The following description will be based on these numerical data, but it should be understood that this is done by way of illustration, and that while those data are the usual ones and are assumed in the embodiments of the invention to be described, they do not constitute a limitation. Therefore, the invention might be carried into practice on a 42″ fuel pipeline by effecting vertical displacements different from 22 cm over lengths of pipeline different from 30 meters, provided that the ratio between the vertical displacement and the pipeline length is such as to be permitted by the international standards and such as not to exceed what is permitted by the elasticity of the pipeline. Likewise, different ratios of vertical displacement to pipeline length are permissible for different pipelines, depending on their structure and dimensions, and the characteristics of the metal from which they are made.

Maintenance of pipelines is first carried out by selecting a number of points along the pipeline segment that requires maintenance. The pipeline segment at these points may be raised by an amount that the height difference between these points does not exceed the international flexibility standards. For example, the segment of a standard 42″ fuel pipeline selected is 30 meters long and the extent to which the terminal cross-section is raised is not more and preferably close to 22 cm. The initial cross-section of the selected segment rests on the bed of the trench because of its weight and no action is required to cause this to occur. Therefore, if a cross-section of pipeline is raised by more than what is permitted by the international standards, which reflects the typical elasticity of pipelines, there is danger that the pipeline will fail and the transported liquid will spill out. Presently, said standards allow a standard 42″ fuel pipeline cross-section to be raised by no more than 22 cm. Raising a cross-section by said amount, will cause the pipeline to bend upwards over a length of 30 meters.

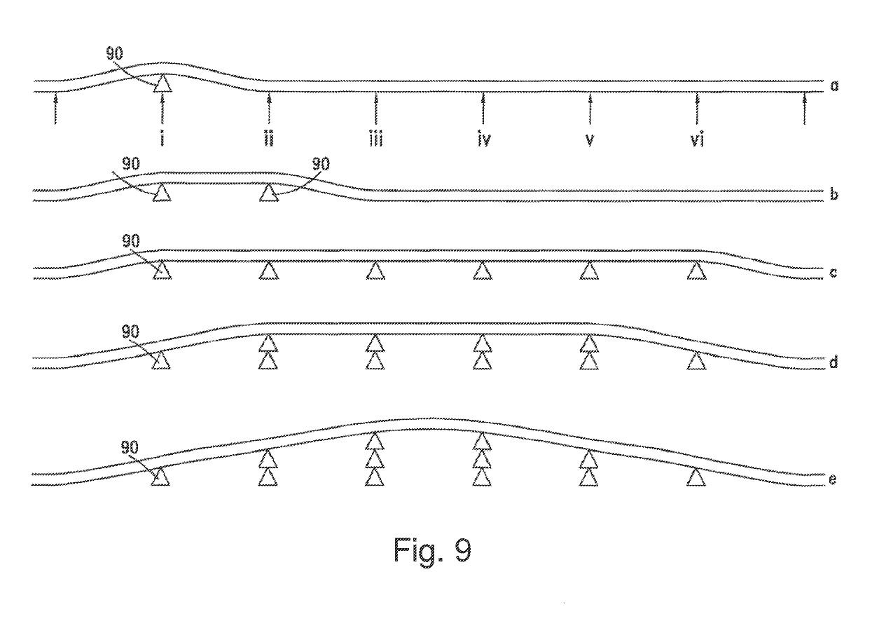

Maintenance of a given pipeline segment requires clearance on all sides, typically a clearance of 60 cm for a standard 42″ fuel pipeline. Thus, the maintenance of a pipeline involves a multi-step process, as schematically illustrated by way of example in FIGS. 9a to 9e. After exposure, the pipe is initially raised at one point by 22 cm (FIG. 9a), by means of the lifting apparatus described hereinafter, and a cradle support such as a sliding cradle, the preferred structure of which will be described hereinafter, is placed thereunder. The lifting apparatus is then relocated to another point and the pipe is there raised by 22 cm (FIG. 9b). The second point will be at most 30 m distant so that the length of pipe suspended between the two supports can bear its own weight without being structurally compromised. This is repeated several times so that the pipeline segment is raised at six points along its length (FIG. 9c). The pipe is then raised by another 22 cm at each of the four inner points (ii, iii, iv, v) and additional supports are stacked onto those already present at the aforesaid points (FIG. 9d). The lifting and supporting procedure is repeated at the two innermost points (iii, iv), yielding a situation where the middlemost pipe segment is suspended by no more than 45-50 cm above the trench bottom (FIG. 9e). Maintenance operations can then be performed on that segment. When the maintenance operations are completed, the pipeline can be lowered and returned to its original position on the padding material at the bottom of the trench by carefully reversing the raising procedure.

It is clear to one skilled in the art that this method can be continued along the pipeline section that is to undergo maintenance by carefully raising and lowering the pipeline segments and adding or removing the pipeline supports. It is equally clear that the procedure is only one of many possibilities of combining the raising, supporting and lowering steps to perform maintenance along the pipeline. One variation might be to raise long sections of the pipeline to a height sufficient to perform maintenance.

The values of 30 meters and 22 cm reflect the present international flexibility standards for 42″ carbon steel pipeline, and would be changed if such standards were changed, based on a different evaluation of the pipelines elasticity. Likewise, different figures would apply to different pipelines.

The difference in height between any two adjacent points of the pipeline is less than a permissible vertical displacement value in accordance with said flexibility standard.

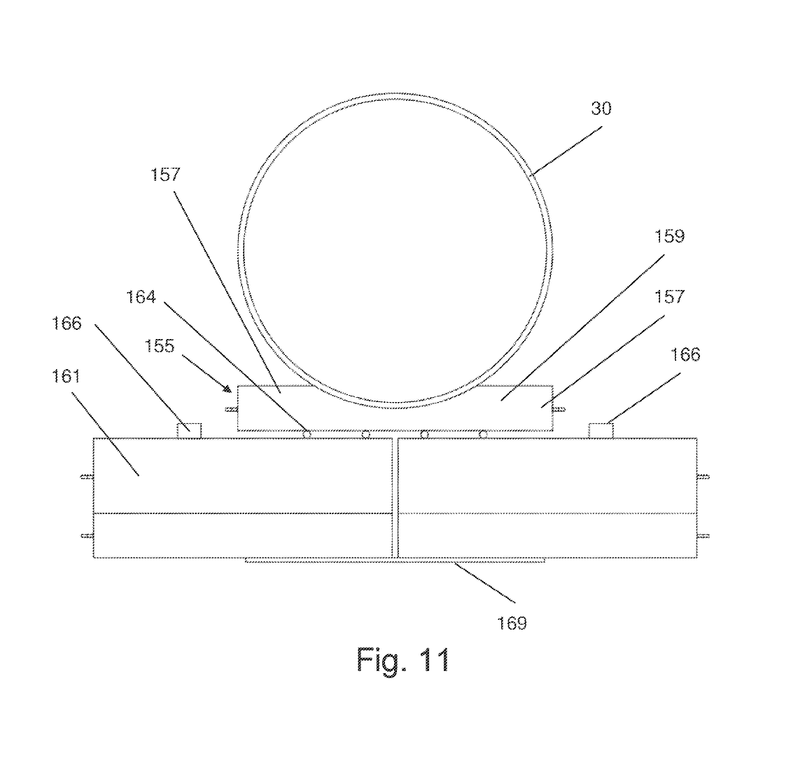

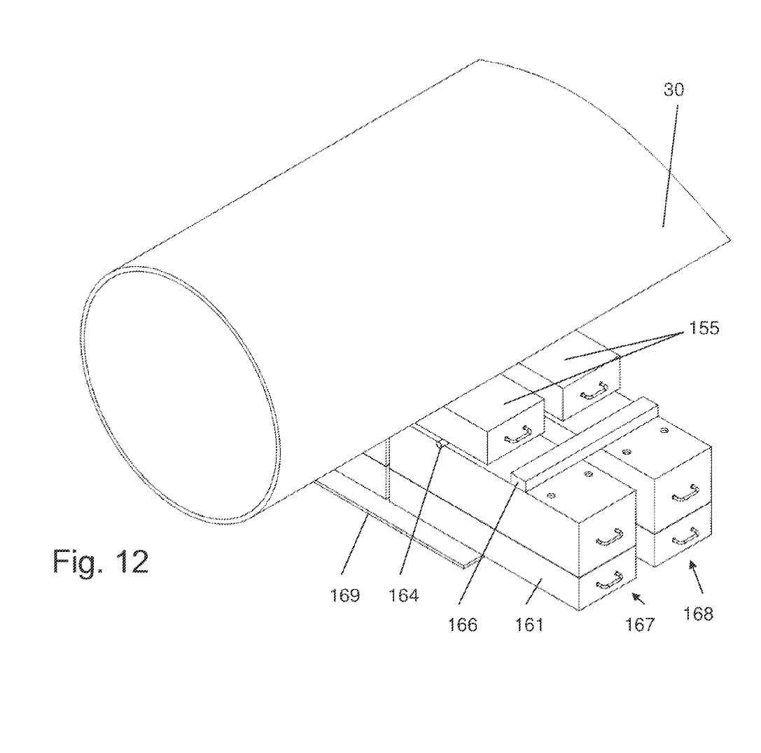

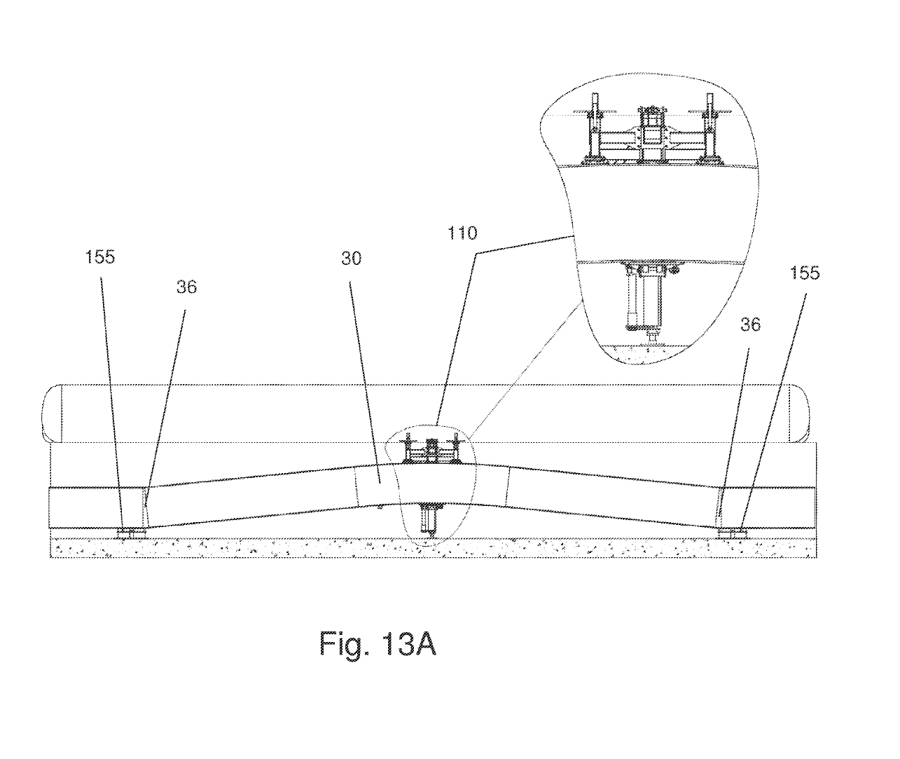

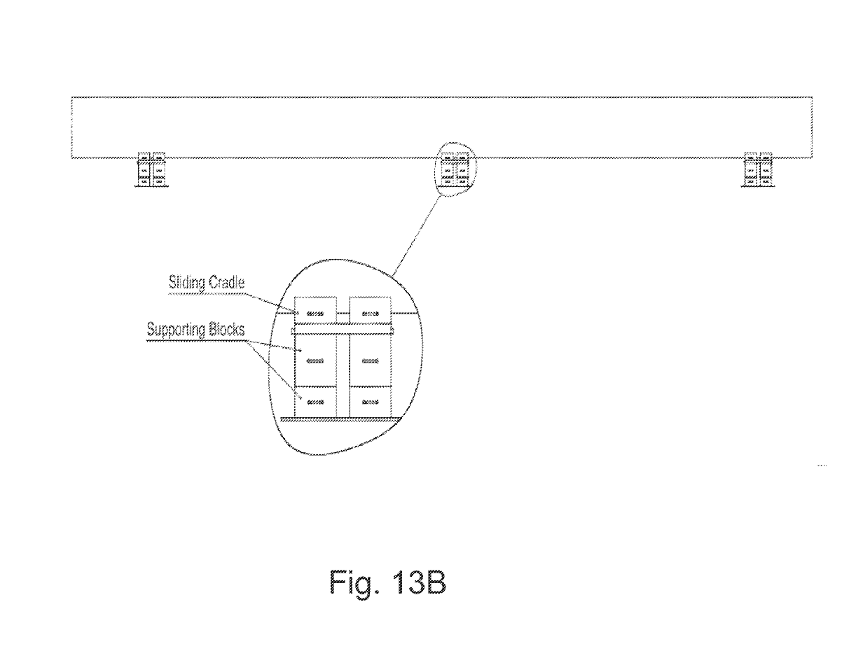

Alternatively, the bottom of longitudinal ends 36 of a pipeline segment 30, e.g. having to length of 200 ft, may be supported by two longitudinally spaced sliding cradles 155, as illustrated in FIG. 11 and FIG. 13A. FIG. 13B shows the pipeline segment 30 when supported by 3 sliding cradles 155. The sliding cradles 155 are used to relieve the stress normally experienced by a pipeline during thermal elongation during periods of extreme temperature fluctuations of as much as 30° C., often causing the pipeline to curve and at even at times to structurally fail.

Each sliding cradle 155 has two parallelepipedal portions 157 and a central concave portion 159 interposed between the parallelepipedal portions in which the bottom of pipeline segment 30 is received. Each sliding cradle 155 extends transversally and may be positioned on top of one or more transversally adjacent rectilinear supporting blocks 161. A balancing plate 169 placed below a lowermost supporting block 161 may be used when the underlying terrain is not level.

After stacking and immobilizing one or more levels of supporting blocks 161 in the manner shown in FIGS. 9a-e, a plurality of transversally spaced rollers 164 are placed on top of the uppermost layer of supporting blocks 161. Transversally spaced from each transversal end 156 of sliding cradle 155 is affixed a corresponding longitudinally extending position limit element 166 to the uppermost supporting block 161. If two longitudinally spaced stacks 167 and 168 of supporting blocks 161 are employed at each longitudinal end 36 of pipeline segment 30, the rollers 164 and limit elements 166 may be placed on top of both stacks. Cradle 155 remains in contact with rollers 164 when pipeline segment 30 is lifted.

The pipeline normally becomes deformed when subjected to temperature fluctuations. By virtue of the presence of the sliding cradle 155, however, a force is applied onto the cradle when the pipeline becomes elongated. The cradle 155 is caused to transversally slide in response to the applied pipe derived force. The maximum transversal displacement of the cradle 155 is defined by the position of the two limit elements 166. In this fashion, pipeline deformation is minimized.

FIG. 2E illustrates another embodiment of the invention. This comprises two lifting frames that are equal and parallel to each other, one of which is generally indicated at 60. They are interconnected by a beam such as 11 in FIG. 2B. When the apparatus is placed in the pipeline trench, the frames are perpendicular to the trench and consequently the beam is parallel to the trench. Each frame comprises two telescopic legs 62 and 63. Each leg rests on a foot. 64 and 65 respectively, to which are connected pistons 66 and 67 respectively, actuated by hydraulic systems. Legs 62 and $3 are connected by a transverse beam 70 to which may be connected a link for lifting the frame by means of a crane.

The transverse beam 70 supports cylinders 73 and 74 respectively of two hydraulic, extendable lifting arms generally indicated at 80 and 81. The lifting arms are connected, in any suitable way, to a sling 79 (shown in broken lines) which is adapted to be placed about the pipeline, the cross-section of which is illustrated at 83. Two hydraulic fingers 84 may engage the top of the pipe to steady it.

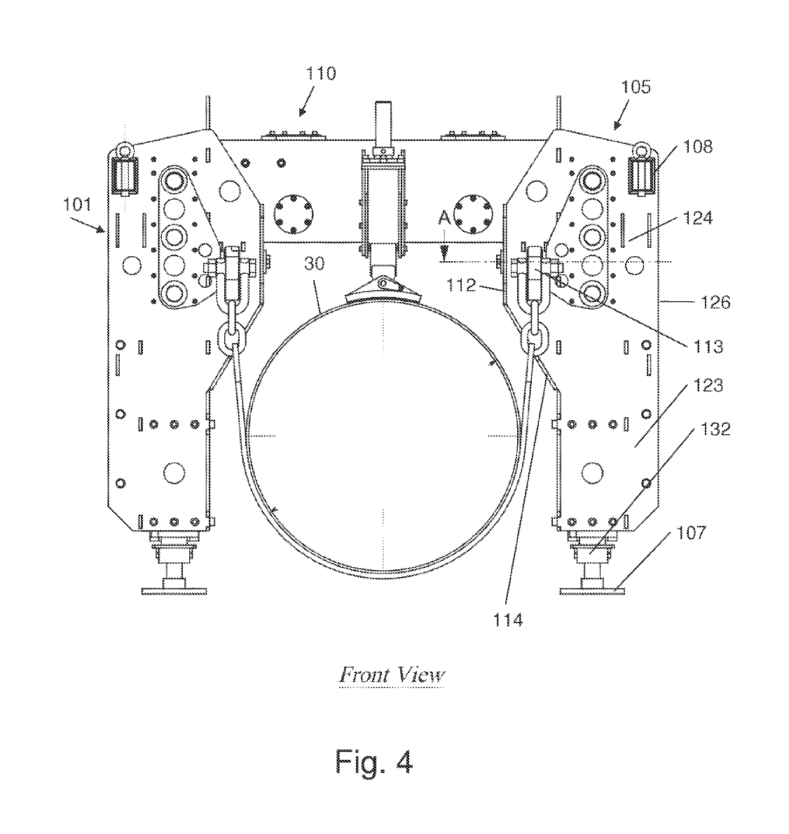

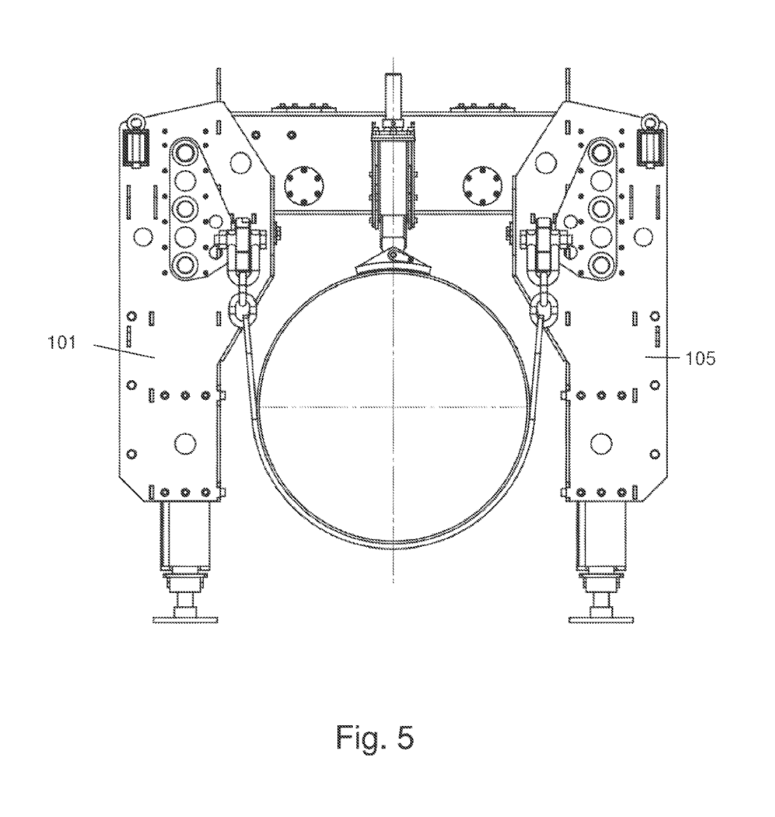

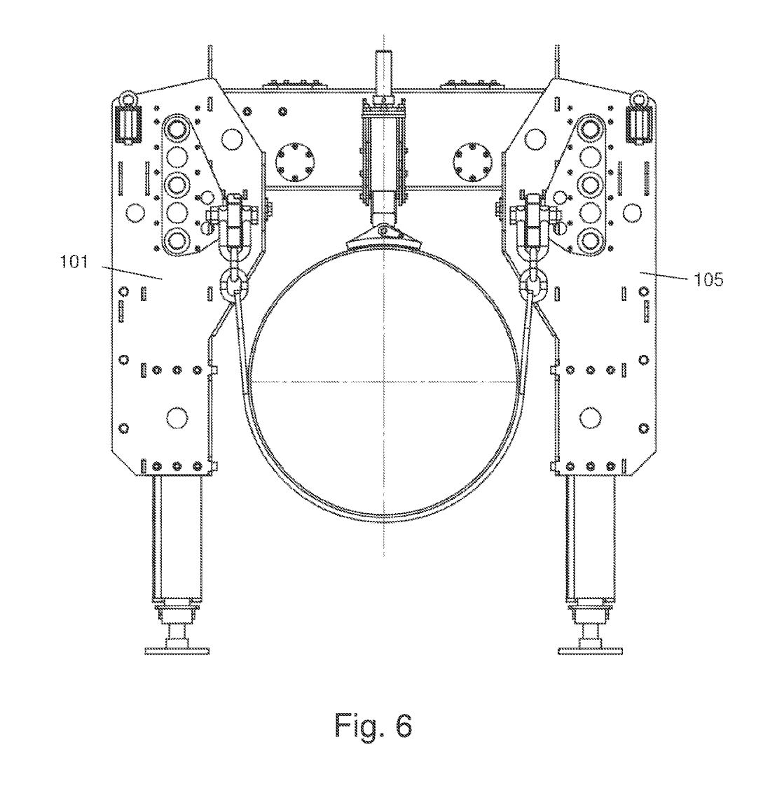

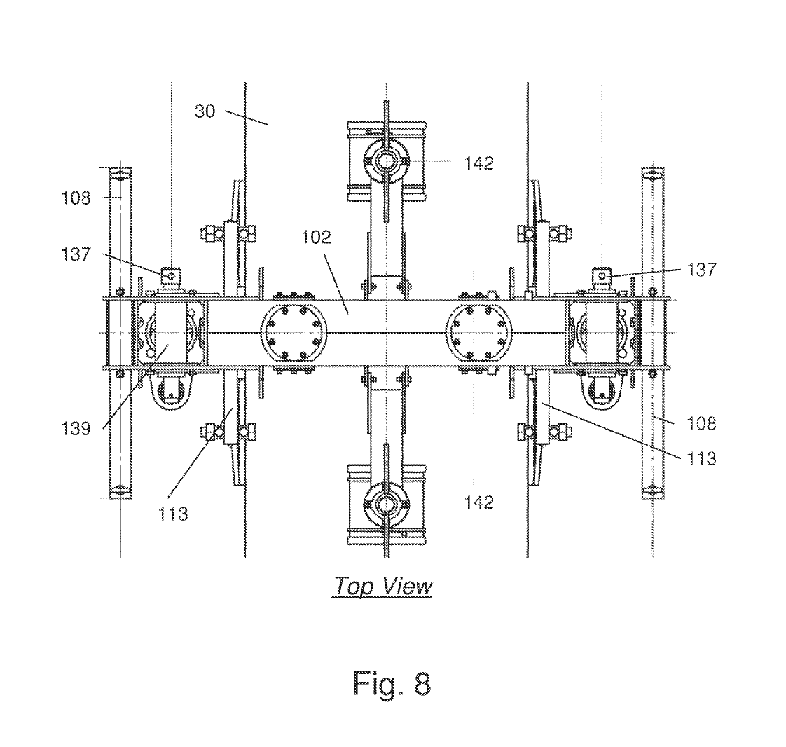

FIGS. 3-8 illustrate another embodiment of the lifting apparatus to which the sling is connected, and is generally designated by numeral 110. FIG. 3 illustrates a perspective view thereof. A front view of the lifting apparatus is illustrated in FIGS. 4-6, a side view thereof is illustrated in FIGS. 7A.-B, and a top view thereof is illustrated in FIG. 8. Lifting apparatus 110 is made of steel or of any other structurally strong material, and is used for raising pipeline segment 30.

Lifting apparatus 110 comprises two transversally spaced and vertically extending lifting frames 101 and 105, a transversally extending adjustable beam 102 interconnecting lifting frames 101 and 105, two longitudinally extending and transversally spaced support beams 108 which pass through a corresponding frame and are raisable by a crane, a longitudinally extending balance beam 113 for suspending a corresponding chain portion 37 of two longitudinally separated slings 29 that engage the bottom of pipeline 30, and two longitudinally separated manually actuated force applicators 116 that are engageable with the top of pipeline 30. Adjustable beam 102 may be perpendicular to lifting frames 101 and 105, and each support beam 108 may be perpendicular to the corresponding lifting frame.

The following description is made with respect to lifting frame 105, but it will be appreciated that the description similarly applies to lifting frame 101.

Lifting frame 105 comprises two identical longitudinally spaced plates 118 and 119, which have a relatively narrow lower portion 123 and a relatively wide upper portion 124 configured with a common straight outer edge 126. A plurality of vertically spaced rods 127 extend between plates 118 and 119. Each support beam 108 and balance beam 113 passes through a corresponding wide upper portion 124 of the frame, and is configured such that the support beam 108 is positioned above, and outwardly spaced from, the corresponding balance beam 113. Lifting frame 105 rests on an extendable foot 107, to which is connected a piston 132 actuated by a hydraulic system.

The first stage of the lifting operation for this embodiment is essentially the same as described hereinabove. Piston 132 of each frame is actuated so as to telescopically extend the corresponding foot 107 until sling 29 is tight. Thereinafter, pipeline segment 30 is raised during the second stage.

Prior to raising pipeline segment 30, force applicators 11.6 are separated from the top of the pipeline by manipulating the corresponding mechanical actuator 128 or by raising cross element 141 extending from actuator housing 142 to vertical guide elements 146 attached to side wall 148 of beam 102.

With reference particularly to FIGS. 3 and 7B, two adjacent hydraulically actuated pistons are positioned within lifting frame 105. Piston 132 is connected to foot 107 and piston 136 is located thereabove for raising pipeline segment 30. A divider 133 is fitted in cylinder 131 within which pistons 132 and 136 are housed, separating cylinder 131 into two sections. Bottom piston 132 is therefore forced to extend downwardly while upper piston 136 is forced to extend upwardly.

A single pin 137 extending between, and protruding outwardly from, plates 118 and 119 at an upper region thereof is used to raise lifting frame 105. Pin 137 is inserted within an aperture 143 formed in each of plates 118 and 119 and also by a frictional fit within a cavity formed within rectilinear block 139, which is brought in abutting engagement with the inner face of plates 118 and 119. Upper cylinder 136 is connected to block 139 at a recess formed at the bottom thereof.

A vertical slot 151 is formed within plates 118 and 119, proximate to short inner edge 112 thereof and above oblique edge 114 extending from upper portion 124 to lower portion 1.23. A balance beam 1.13 having a straight upper edge 115 and a varying lower edge 117 for increased structural strength is inserted within the two slots 151. The chain portion 37 of a sling 29 is connected to a corresponding narrow terminal end 121 of balance beam 113 by a fastener 122. Consequently when upper piston 136 is actuated and extended, pin 137 is raised together with lifting frame 105. After lifting frame 105 is slightly lifted, the bottom wall 153 of slot 151 contacts lower edge 117 of balance beam 113, causing balance beam 113 together with pipeline segment 30 to be also raised.

Assistance in ensuring stability of lifting apparatus 110 during the second stage of the lifting operation may be provided by a crane associated element connected to eyelets 95 provided with each of the two support beams 108. Each eyelet 95 is located near a corresponding end 106 of a support beam 108, and protrudes upwardly from the upper face thereof.

A corresponding reinforcing element 129 is welded to the outer face of plates 118 and 119, in order to reinforce each plate at high stress regions, namely in the vicinity of pin 137 and slot 151. Reinforcing element 129 may be embodied by a thin triangular plate positioned between support beam 108 and balance beam 113. Vertically separated apertures 134, 135 and 138 may be formed within reinforcing element 129 in order to coincide with apertures 143-445, respectively, formed within each of plates 118 and 119. Thus pin 137 may be removed from apertures 134 and 143 and inserted into a different pair of apertures when it is desired to raise a pipeline segment having a different diameter.

It will be appreciated that the pipeline may be supported by the cradle shown in FIG. 11.

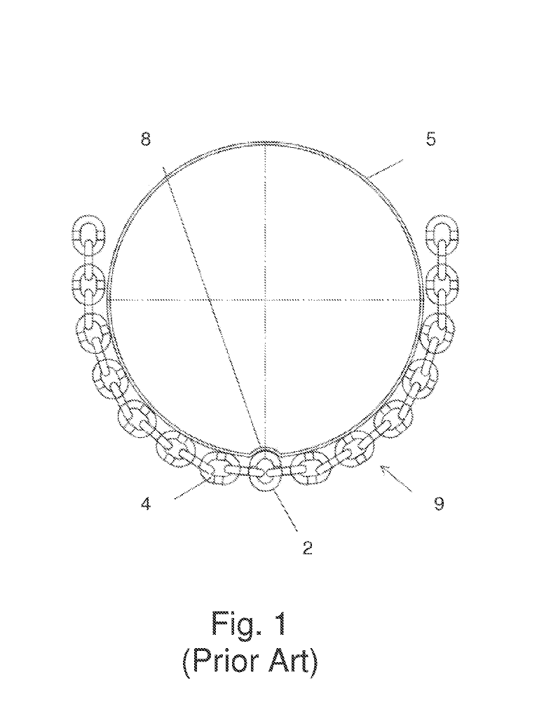

As shown in FIG. 1.0, lifting apparatus 110 may be advantageously employed to raise a pipeline segment 30 embedded in terrain 96 that is disposed at an incline of angle I with respect to a horizontal plane 93. After some of terrain 96 is removed to form a small clearance C below pipeline segment 30, a pair of spaced hybrid slings 29A and 29B are passed underneath the pipe such that the belt portion 34 of each is brought in engagement with the bottom of pipeline segment 30.

A crane then lowers lifting apparatus 110 onto inclined trench bed 92 until lifting frame 105 is perpendicular thereto. A hook element 103 having a vertically disposed rod 104 connected to the crane (not shown) facilitates this procedure. Hook element 103 is engageable with two chains 107A and 107B connected to, and extending upwardly from, lifting apparatus 110. The terminal link 109 at each free end of a chain is connected to a corresponding eyelet 95 of support beam 108, and a central portion 111 of the chains is passed over, and in contact with, hook element 103.

In order to accommodate the inclined terrain, the height of each force applicator 116 with respect to trench bed 92 may then be adjusted to ensure that the top of the pipeline will be engaged thereby.

Support beams 108 are positioned to be at the same angular disposition with respect to horizontal plane 93 as pipeline segment 30, i.e. they are spaced by a uniform height H from the longitudinal axis 33 of pipeline segment 30. After support beams 108 become correctly positioned, the sling chain portions 37 and the overlying chains 107A-B become automatically repositioned with respect to the relative location of hook element 103. Since rod 104 extending upwardly from hook element 103 is vertically disposed, the crane is able to apply an easily generated vertical lifting force L while pipeline segment. 30 can be raised parallel to the disposition of trench bed 92 and obviating the need of having to dig in some regions a large clearance trench if the pipeline were vertically raised.

While embodiments of the invention has been shown has been described by way of illustration, it will be understood that the invention may be carried into practice with many modifications, variations and adaptations, without exceeding the scope of the claims.

1. Apparatus for lifting and supporting pipelines through which is flowable fuel, gas or hazardous industrial liquids, for maintenance and restoration purposes, comprising a hybrid sling for supporting a pipeline segment when being raised, said sling comprising a flexible belt portion contacting an underside of said pipeline segment and a chain portion vertically extending from each end of said belt portions to an element through which a lifting force is transmittable, wherein said sling is assured of being sufficiently structurally strong and dimensionally stable to ensure that the difference in height of any two points of said segment when being raised is riot so great as to create a danger to the integrity of the pipeline.

2. The apparatus according to claim 1, wherein each of the chain portions is connected to a raisable member of a lifting apparatus through which the lifting force is transmittable, said lifting apparatus comprising two transversally spaced lifting frames and a transversally extending beam interconnected with said two lifting frames.

3. The apparatus according to claim 2, further comprising a first hydraulic system for telescopically extending and retracting a corresponding foot on which each of the two lifting frames rests, wherein said first hydraulic system has insufficient power to extend said foot to lift the pipeline, and a second hydraulic system independent from said first hydraulic system for applying the lifting force to lift the pipeline or a lowering force to lower the pipeline.

4. The apparatus according to claim 3, wherein the first and second hydraulic systems are positioned with an interior of each of the two lifting frames and a piston of the first hydraulic system is connected to the corresponding foot.

5. The apparatus according to claim 4, wherein the raisable member is a longitudinally extending beam that passes through, and is engaged by, a corresponding lifting frame and a piston of the second hydraulic system is configured to apply a lifting or lowering force to a pin attached to the corresponding lifting frame, the lifting or lowering force applied to said pin being transmitted to the longitudinally extending beam.

6. The apparatus according to claim 5, wherein the pin is releasably attachable to a block which is positioned in abutting engagement with an inner face of the corresponding lifting frame and is connected to the piston of the second hydraulic system, a selected attachment position of the pin in one of a plurality of apertures formed in the corresponding lifting frame defining a stroke of the piston of the second hydraulic system and a height to which the pipeline segment is raised.

7. The apparatus according to claim 6, further comprising a reinforcing element welded to an outer face of the corresponding lifting frame in the vicinity of the pin and the longitudinally extending beam.

8. The apparatus according to claim 2, wherein the raisable member is a telescopic lifting arm.

9. The apparatus according to claim 2, wherein the transversally extending beam is dimensionally adjustable.

10. The apparatus according to claim 1, further comprising two longitudinally separated and manually actuated force applicators that are engageable with a top of the pipeline segment.

11. The apparatus according to claim 2, wherein a longitudinally extending support beam passes through a corresponding lifting frame and is raisable by a crane.

12. The apparatus according to claim 11, further comprising a crane related chain connected to, and extending upwardly from a corresponding support beam disposed at a same angular disposition with respect to a horizontal plane as the pipeline segment and a hook element connected to a crane, for supporting a central portion of the two crane related chains and thereby allowing the pipeline segment to be raised by the crane in a direction parallel to an inclined disposition of terrain in which the pipeline is embedded.

13. The apparatus according to claim 12, wherein each crane related chain is connected to the corresponding support beam by means of partially open eyelets protruding from the corresponding support beam.

14. The apparatus according to claim 1, wherein the belt portion is resistant to acids and has an elongation ranging from 3 to 5%.

15. The apparatus according to claim 14, wherein the belt portion is made from polyester.

16. The apparatus according to claim 1, wherein two longitudinal ends of the pipeline segment are supported by a corresponding sliding cradle assembly.

17. The apparatus according to claim 1, further comprising a support in contact with the pipeline at a corresponding lifting location, said support including one or more stackable elements including a concave element for engaging the bottom of the pipeline, wherein said concave element has a substantially similar curvature as that of the pipeline to conform to the surface of the pipeline.

18. The apparatus according to claim 1, wherein the difference in height between any two adjacent points of the pipeline is less than a permissible vertical displacement value in accordance with a flexibility standard.

19. A support assembly for a longitudinal end of a raised pipeline segment through which is flowable fuel, gas or hazardous industrial liquids, comprising a sliding cradle assembly that includes a concave portion for engaging a bottom of a raised pipeline segment and that is transversally slidable in response to an applied temperature related, pipe derived force.

20. The support assembly according to claim 19, wherein the sliding cradle assembly comprises a monolithic member configured with the concave portion and two rectilinear portions between which the concave portion is interposed, at least one rectilinear supporting block, a plurality of transversally spaced rollers placed on top of an uppermost layer of said at least one supporting block, and two longitudinally extending position limit elements affixed to said uppermost layer of supporting blocks and transversally spaced from transversal ends, respectively, of said monolithic member, a maximum transversal displacement of said monolithic member being defined by a position of said two position limit elements.
